(19) United States
(12) Patent Application Publication
(10) Pub. No.: US 2006/0058985 A1
(43) Pub. Date: Mar. 16, 2006

(54) Adjoint-based design variable adaptation

(75) Inventors: Alan E. Arslan, Santa Clarita, CA (US); John M. Morgenstern, Lancaster, CA (US); Josiah David Jordan, Canyon Country, CA (US)

Correspondence Address: KOESTNER BERTANI LLP, 18662 MACARTHUR BLVD, SUITE 400, IRVINE, CA, 92612, US

(73) Assignee: Supersonic Aerospace International, LLC, Las Vegas, NV (US)

(21) Appl. No.: 10/930,375

(22) Filed: Aug. 31, 2004

(51) Int. Cl. G06F 17/10

(52) U.S. Cl. 703/2

(57) ABSTRACT

A method for determining an optimum design includes determining an initial field solution for a design configuration based on an initial set of design variables; determining an adjoint solution to the field solution; determining the regions of interest on the design configuration based on magnitudes and/or gradients of the adjoint solution; and establishing design variables at the regions of interest.

### BACKGROUND OF THE INVENTION

Computational simulation has come to play an increasingly dominant role in the engineering design process. Computer aided design (CAD) methods have essentially replaced the drawing board as the basic tool to define product configurations. Similarly, structural analysis is now almost entirely carried out by computational methods typically based on the finite element method. Commercially available software systems such as NASTRAN, ANSYS, or ELFINI have been progressively developed and augmented with new features, and can treat the full range of structural requirements.

Computational fluid dynamics (CFD) is a computer-based technology that studies flluid dynamics. CFD involves building a computer-simulated model of a product, such as an airplane or race car, and then applying the laws of physics to the virtual prototype to predict the forces on various components of the product or the product's response in various operating conditions and environments. Engineers can use CFD to better visualize and enhance their understanding of how various designs will perform. It also allows them to vary selected design parameters in a relatively short amount of time until they arrive at optimal results.

CFD allows engineers to use computer software to divide components of a product such as a car or airplane into specific cells, elements, or grids. For each of those cells, computers are then used to calculate the velocity and air pressure of the air flow as it rushes over, under and around the specified components of the product. Engineers can use the resulting data to compute the forces the product will experience, depending on different environmental conditions and design variables. When the calculations are finished, the engineer can analyze the results either numerically or graphically.

To ensure the realization of the true best design, the ultimate goal of computational simulation methods should not just be the analysis of prescribed shapes, but the automatic determination of the true optimum shape for the intended application. Determining an optimal design using finite element analysis and CFD includes subdividing the design into a grid of elements; identifying design variables or parameters that can be adjusted during the design process; identifying an objective function to be minimized; and identifying constraints that must be satisfied.

Methods for improving the efficiency of the design process are continually being sought. In numerical optimization, for example, the computational resources required to evaluate objective functions by means of the traditional method of finite differences is proportional to the number of design variables used to define the geometry deformations. The finite difference method can therefore be very demanding and even prohibitive in practical situations. An alternative for decreasing the computing time is to apply control theory to determine an optimal solution. The main advantage is that the computing time is almost independent of the number of design variables.

### SUMMARY OF THE INVENTION

Systems and methods for adaptively determining design variables that can be adjusted during the design process are provided.

In some embodiments, a method for determining an optimum design includes determining a field solution for a design configuration based on an initial set of design variables; determining an adjoint solution to the field solution; determining the regions of interest on the design configuration based on gradients and magnitudes of the adjoint solution; and establishing design variables at the regions of interest.

### BRIEF DESCRIPTION OF THE DRAWINGS

Embodiments of the invention relating to both structure and method of operation, may best be understood by referring to the following description and accompanying drawings.

FIG. 1 is a flow diagram of an embodiment of a process for adapting design variables based on the gradients of an adjoint field solution;

FIG. 2 is a top view of an aircraft overlaid with example design variables;

FIG. 3 is a side view of the aircraft shown in FIG. 2 further illustrating the example design variables;

FIG. 4 is a side view of a wing cross-section showing field contours from a field solution;

FIG. 5 shows field contours for the adjoint solution to the field solution isocontour distribution shown in FIG. 4;

FIG. 6 shows shock waves formed on an engine nacelle according to a field solution;

FIG. 7 shows “reverse” shock waves for the adjoint solution to the field solution shock waves shown in FIG. 6;

FIG. 8 shows a region of interest for the adjoint solution shown in FIG. 7;

FIG. 9 shows a wing overlaid with grid portions;

FIG. 10 shows a flow diagram of another embodiment of a process for adapting design variables based on the gradients of an adjoint field solution using Cartesian grid refinement;

FIG. 11 shows a flow diagram of another embodiment of a process for adapting design variables based on the gradients of an adjoint field solution using a genetic algorithm; and swarming technique

FIG. 12 shows a diagram of an embodiment of a system that can be used to implement processes for adapting design variables based on the gradients and magnitudes of an adjoint field solution.

### DETAILED DESCRIPTION OF THE EMBODIMENTS

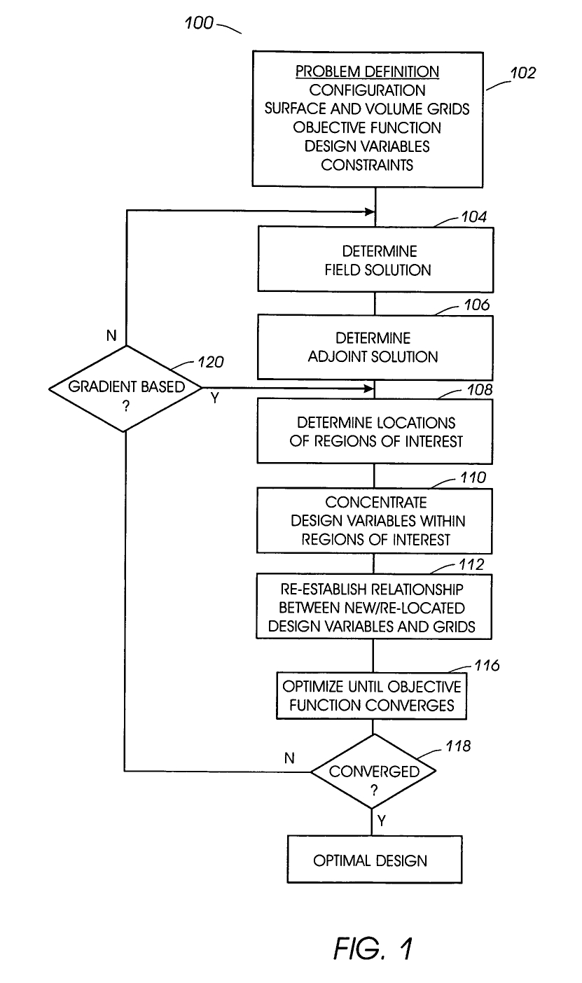

Referring to FIG. 1, a flow chart of a process 100 for refining the location of design variables used to analyze a product configuration is shown. After determining initial design variables, constraints, objective function, and surface grids in process 102, processes 104 and 106 combine computational field simulation with numerical optimization methods to compute a field solution and the corresponding adjoint solution, as described for instance in “Aerodynamic Shape Optimization using the Adjoint Method” by Antony Jameson, Lectures at the Von Karman Institute, Brussels, Feb. 6, 2003. Process 108 extends the adjoint method by determining regions of interest based on lines of equal magnitude (isocontours) in the adjoint field solution. Process 110 creates, removes, or re-locates design variables to the regions of interest. The relationships with the surface grids and corresponding sensitivities are re-established with the new design variables in process 112.

The ability to adapt the design variables to regions of interest in process 100 allows more rapid convergence to the optimal configuration compared to traditional techniques. In fact it opens new avenues in the design space. In the traditional adjoint methods, the cost of solving the adjoint equation is comparable to the cost of solving the field equations, with the consequence that the gradient with respect to a relatively large number of design variables can be calculated with roughly the same computational cost as one field solution. Once the gradient has been calculated, a descent method can be used to determine a shape change that will make an improvement in the design and therefore converge to an optimum. The gradient can then be recalculated, and the process repeated until the design converges to an optimum solution, usually within 10-50 cycles. The fast calculation of the gradients in the adjoint method makes optimization more computationally feasible than optimizing the design using the field equations with sensitivities computed in the forward mode (i.e., Finite difference, Semi-Analytical method, or complex variables—even without sensitivities), even for designs in three-dimensional viscous flow. Dynamically adapting the design variables to regions of interest as disclosed herein further improves the optimization process using the adjoint equations.

Process 102 includes defining a configuration, setting up grids for field analysis, parameterizing a control function to be optimized (an airfoil shape, for example) with a set of design variables, and determining a suitable objective function to be minimized or maximized, such as drag coefficient, lift/drag ratio, difference from a specified pressure distribution, etc. Then, one or more constraints (either field-related or control function related) can be introduced in order to express the dependence between the objective function and the control function.

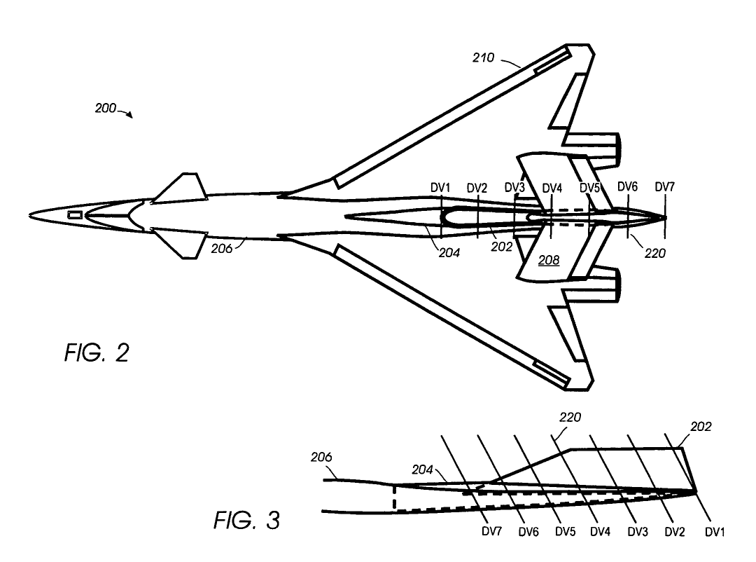

FIGS. 2 and 3 show an example of initial locations of design variables DV1-DV7 for aircraft 200 that can be used to determine an optimum configuration for vertical fin 202 and strake 204. The optimization can be performed on individual components, or combinations of components, such as vertical fin 202, strake 204, fuselage 206, inverted V-tail 208, and/or wing 210. Additional design variables can be used in certain analysis methods, such as computational fluid dynamics (CFD), to simultaneously determine optimum configurations for a combination of vertical fin 202, strake 204, fuselage 206, inverted V-tail 208, and wing 210. The design variables can be optimized along Mach angle lines 220, which vary according to the Mach number. Thus, an optimum configuration for the components such as vertical fin 202, strake 204, and inverted V-tail 208 can vary between Mach numbers.

Any suitable number and location of design variables can be used, depending on the geometry of a specific configuration. Design variables may also be combined arbitrarily (i.e., design curves). Additionally, a combination of parameters and their nth-order derivatives can also be used as design variables in orthogonal functions such as Fourier series and Legendre polynomial functions, as well as non-orthogonal functions such as Taylor series. Use of first and second order derivatives as design variables typically achieves smoother shapes than cross-sectional area and thickness alone. Such techniques can be applied to calculate the field for any suitable type of product, including aircraft, watercraft, electrical/electronics devices, and automobiles, among others.

The surface grids can be configured using any suitable method(s). An example of a suitable method is referred to as adaptive mesh refinement (AMR), which is a computational technique for re-subdividing the design into a grid of elements to improve the efficiency/accuracy of numerical simulations of systems of partial differential equations. The AMR technique includes refining, both in space and in time, regions of the computational domain in which high resolution is needed to resolve developing features, while leaving less interesting parts of the domain at lower resolutions. Finer grids are adaptively placed in subregions that require a better resolution over the coarse grid covering the region. The solution on each fine subgrid can then be approximated by standard finite difference techniques, as performed on the coarse grid. In solving a time dependent problem, the difficult regions will change in time, where time could be fictitious (convergence to steady-state for example), and thus the grid adapts in time in response to the solution.

The constraints and objective functions can also be determined using any suitable method(s). Constraints are restrictions on the design variables and/or configuration and/or field-derived parameters such as forces and moments that must be satisfied in an acceptable design. A feasible design will satisfy all of the constraints. The objective function is a function of the design variables that measures the value or cost of a particular design. An optimum design produces the best value of the objective function for the given constraints. The geometry of the device is defined with the design variables, which may, for example, be weight factors applied to a set of shape functions. Then an objective function is selected that is a function of the weighting factors, which might, for example, be the drag coefficient or the lift to drag ratio when designing an aircraft.

Computing the field solution process 104 includes analyzing the performance of the product design in a field, such as used in various computational fluid dynamics techniques. In the early stages of a new product design, several configurations may be analyzed to determine the best tradeoff between often-competing goals. Thus, in some embodiments, compute field solution process 104 can use linear field equations to evaluate multiple candidates. In the later design stages, however, process 104 can utilize non-linear field equations, which are computationally much more intensive, but provide more accurate results than linear techniques.

The field equations model the behavior of the fluid, gas, electromagnetic waves, or particles within or around the design, such as aircraft, pipes, RADAR signatures, heating and cooling systems, engines, automobiles, trains, and rocks, among others. Any suitable field/modeling equations can be utilized, for example, the Navier-Stokes equations, the Euler equations, potential flow equations, equations of motion, and/or Maxwell's equations, depending on the type of field.

After solving the field equations in process 104, process 106 includes determining the adjoint variables, also referred to as co-state variables, of a given objective function with respect to a given design variable. To calculate the surface and volume adjoint variables, a governing equation R expresses the dependence of the field variables Q and the physical location of the boundary control functional F, and can be expressed as follows:
R(Q, F)=0.
Then, the change in the field, δQ, is determined from the equation
δR=[δR/δQ]_{I}δQ+[δR/δF]_{II}δF=0.
where the subscripts I and II are used to distinguish the contributions due to the variation δQ in the field solution from the change associated directly with the modification δF in the shape.

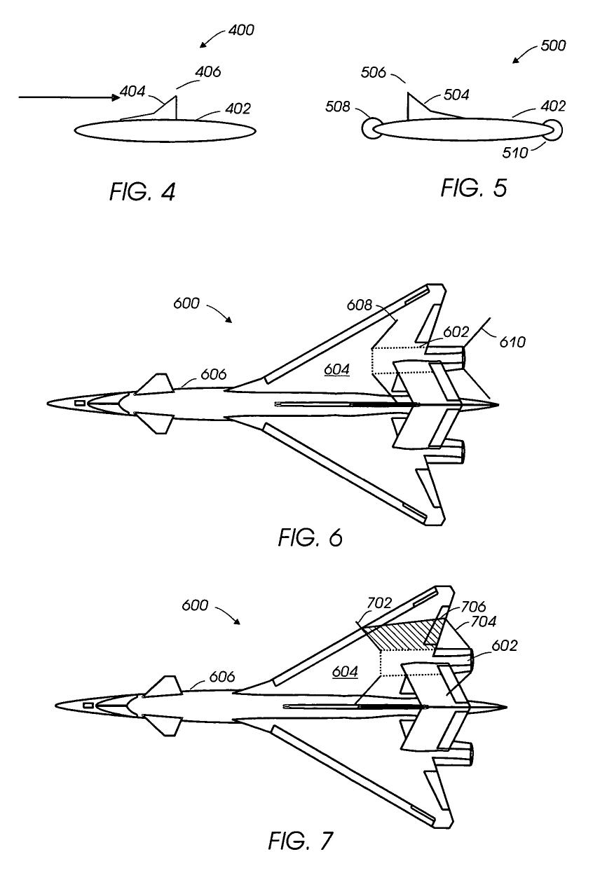

Process 108 includes determining the locations of regions of interest for the design variables. In some embodiments, the regions of interest are found along isobars, which are lines of equal value, in the adjoint solution. As an example of determining regions of interest, FIG. 4 shows a cross-sectional view of a field solution 400 for a wing 402. Mach number distribution 404 on the wing 402 increases until a shock wave 406 forms at a point past the midsection of the upper portion of the wing 402. A shock wave gets formed and is manifested as an abrupt change of pressure, density, or velocity of particles in a field. FIG. 5 shows the adjoint variable contours for the given field solution contour plot 400 shown in FIG. 4. The adjoint solution 500 shows a distribution 504 that mirrors the Mach number distribution 404 for the field solution 400. Notably, the adjoint variable distribution (also called Mach number co-state variable) 504 begins with shock wave 506 and decreases to zero toward the midsection of the wing 402. The adjoint solution 500 shows regions of significant contour gradients 508, 510 at the respective leading and trailing edges of the wing 402. The areas of interest in the design of the wing 402 thus include the areas of the wing 402 where the adjoint variable distributions 504, 508, 510 are located.

As another example of a field solution and corresponding adjoint solution, FIG. 6 shows a cross-sectional view of a field solution for an engine nacelle 602 mounted on wing 604 of aircraft 606. A pressure distribution around the engine nacelle 602 shows V-shaped shock/Mach lines 608, 610 with vertices formed at the respective leading and trailing edges of the engine nacelle 602 extending toward the rear of aircraft 606. FIG. 7 shows the adjoint pressure distribution for the field solution shown in FIG. 6. The adjoint solution shows V-shaped shock lines 702, 704 that mirror the shock lines 608, 610 for the field solution in FIG. 6. The region of interest 706 between the shock lines 702, 704 is cross-hatched to indicate the location of design variables that will have the greatest impact on the shape of the design for the wing 604 based on the presence of the engine nacelle 602. For example, installation drag could be reduced by using the aforementioned variables.

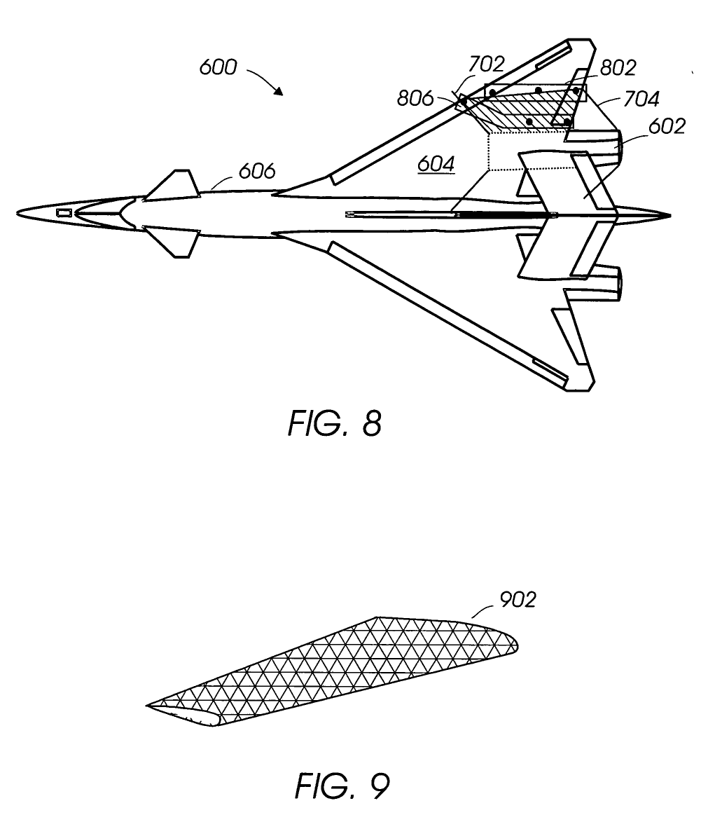

Once the region(s) of interest are determined in process 108, process 110 includes creating new design variables, and/or moving the existing design variables, to the regions of interest. FIG. 8 shows the aircraft 606 of FIG. 7 with an initial set of design variables 802, region of interest 804, and a new set of design variables 806. The new set of design variables 806 are located within the region of interest 804, whereas some of the initial design variables 802 were located outside the region of interest 804. Note that the new design variables 806 can be used in addition to, or instead of, the initial set of design variables 806. In the process of creating the new set of design variables 806, different aspects of the design may be considered. For example, an initial set of design variables may be selected to determine optimum thickness for a given lift/drag ratio constraint. Once the adjoint solution is determined, additional design variables, such as width or height, can be used subject to the same or different geometric or structural constraints.

Once the new design variables 806 are established, process 112 includes re-establishing the relationships with surface grids and corresponding sensitivities of the objective function I. FIG. 9 shows an example of an initial geometric shape for a wing 902 overlaid with a computational grid. Each section of the grid is defined by its location with respect to the other grid areas. When a design variable is moved or added, the design variable is associated with the corresponding section of the finite element grid to be modified for further analysis. In some embodiments, the design variables consist of control points, and an “associativity” between the new control points and the surface grids is determined to establish how each design variable affects the corresponding surface gridpoint. This process can be automated, for example, using UNIX scripts. In other embodiments, the design variables consist of sine bumps and when the center of the bump shifts, then the relationship with a finite-element grid can be established automatically or manually by changing an input file.

Process 114 includes determining the gradients of the surface grids (geometry) with respect to the design variables. For example, to obtain the gradients for a wing design, the partial derivative of the geometry of the wing with respect to a design variable such as the thickness of the wing is formed. Process 114 can also include determining the gradients of volume grids for the design with respect to the surface grids. As shown hereinabove, the variation δR is zero (since at convergence R=0), so it can be multiplied by a Lagrange Multiplier ψ and subtracted from the variation in the objective function δI without changing the result, as follows:
δI=[δI^{T}/δQ]δQ+[δI^{T}/δF]δF−ψ^{T}([δR/δQ]δQ+[δR/δF]δF)
δI=([δI^{T}/δQ]−ψ^{T}([δR/δQ])_{I}δQ+[δI^{T}/δF]δF−ψ^{T}[δR/δF])_{II}δF
Choosing ψ to satisfy the adjoint equation:
[δR/δQ]^{T}ψ=[δI^{T}/δQ]
when the first term is eliminated,
δI=GδF
where the gradient G is:
G=[δI^{T}/δF]−ψ^{T}[δR/δF].
As shown by the above formula, the gradient G is independent of the field variables δQ, with the result that the adjoint solution allows the gradient of the objective function I to be determined with respect to an arbitrary number of design variables without additional-field evaluations.

Process 116 optimizes the defined objective function (e.g., drag) while satisfying geometric and performance constraints (e.g. fuel volume and cruise lift coefficient). Configurations can be optimized for single or multiple conditions. Target pressure distributions can be specified for inverse design, or as a constraint during optimization of other performance drivers. Any suitable objective functions and optimization method(s) can be utilized, including a combination of methods.

Process 118 compares the geometry and performance of the design to the constraints, such as lift to drag ratio and geometry constraints, to determine whether a solution has converged to meet all of the desired constraints. If all the constraints have not been met, an optimal design has not been reached, and process 120 returns control to process 104 if gradients are not being evaluated, and to process 108 if gradients are being evaluated.

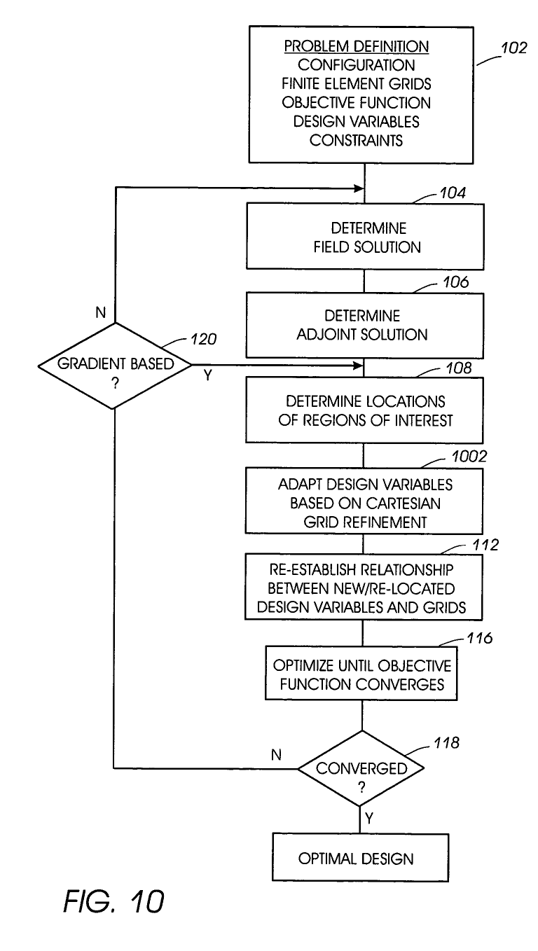

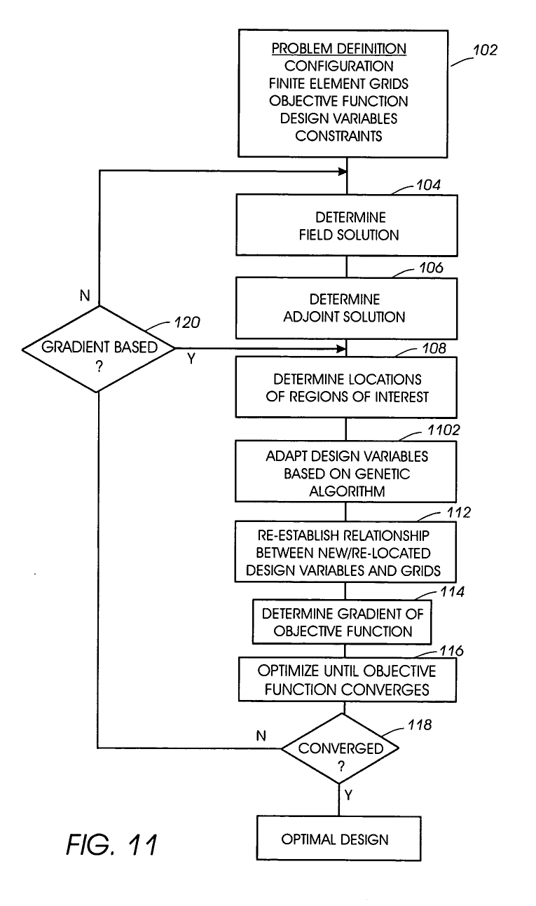

Referring now to FIG. 10, another embodiment of a process 1000 for adapting adjoint-based design variables is shown. Processes 102 through 108, and 112 and 120, are similar to corresponding processes shown in FIG. 1. Process 1002 includes adapting design variables using Cartesian grid refinement. In some embodiments, an octree representation of the design's geometry is used, which includes subdividing different regions of the geometry at different resolutions. Octrees are similar to binary trees, however, an octree has eight children on each internal node and each node corresponds to a volumetric region.

In some implementations, process 1002 subdivides the octree representation of the design when an adjoint gradient exceeds a threshold or when a user requests a refinement to a region of interest. The octree representation can begin with an initial, coarse, octree decomposition of a three-dimensional (3D) bounding box of the domain of a given volumetric data set. Initially, octree cells can be split merely based on the highest adjoint gradients. The splitting process can be terminated when a maximum number of cells is exceeded or when all cell-specific adjoint gradients are smaller than some specified threshold.

In some embodiments of process 1002, the difference between the original data values and the constant value approximations, within each octree cell, can be used as a metric. Using an octree-based approximation, a data-dependent, spatial decomposition can be generated that adapts to the underlying complexity of the design. The techniques deal with the problem of decimating triangular surface meshes and adaptive refinement of tetrahedral volume meshes, respectively. These two approaches are aimed at the concentration of design variables in regions of high gradients. This principle can be used to either eliminate design variables in nearly linearly varying regions (decimation) or to insert design variables in highly curved regions (refinement). In other embodiments, process 1002 inserts octree cells when the metric is large or when a user requests local refinement.

Process 1004 includes an inner loop that optimizes the design until the objective function converges. In some embodiments, the surface and volume grids of the design are perturbed at the beginning of each iteration and the field equations are solved, for example, by performing linear or non-linear CFD analysis. The design variables are then perturbed if the solution does not converge. Once process 1004 completes, then process 118 determines whether the results of the optimization in process 1004 are unchanged after design variable adaptation as well as when the location of the design variables changes are above or below a predetermined threshold after each adaptation. If the results of process 1004 have converged, then an optimal design has been reached. Otherwise, control passes to process 120.

Referring now to FIG. 11, another embodiment of a process 1100 for adapting adjoint-based design variables is shown. Processes 102 through 108, and 112 through 120, are again similar to corresponding processes shown in FIG. 1. Process 1102 includes using a genetic algorithm to determine the optimum locations of the design variables. In some embodiments, process 1102 creates many random “solutions” to the optimization problem. Being random, these starting “solutions” are not likely to be optimal.

The optimal placement of design variables is a chosen subset of a larger set of potential locations so as to minimize an objective or cost function. The solution defines whether a design variable is placed at a potential location or not (i.e., “1” or “0”). The solution can therefore be viewed as a binary string. An initial set of candidate optimal solutions are generated randomly as binary strings. They are then evaluated via a cost function. A subset of high performance candidates are chosen and randomly recombined in pairs. The new candidates are evaluated and the process repeats itself until some user defined conditions are reached. A random subset of candidate solutions are changed randomly so as to introduce a “mutation” to help avoid falling into a local optimization. All of these solutions are coded as a series of zeroes and ones. Process 1102 includes considering these 0s and 1s as genetic “chromosomes” that, like their real-life, biological equivalents, will be made to “mate” by hybridization, also throwing in the occasional spontaneous mutation. The “offspring” generated will include some solutions that are better than the original, purely random solutions. The best offspring are added to the population while inferior ones are eliminated. By repeating process 1102 among the better solutions, repeated improvements will occur in the population, survive and generate their own offspring.

An outline of the basic genetic algorithm is as follows:
1. Generate random population of n chromosomes (suitable solutions for the problem)
2. Evaluate the fitness f(x) of each chromosome x in the population
3. Create a new population by repeating following steps until the new population is complete
4. Select two parent chromosomes from a population according to their fitness (the better fitness, the bigger chance to be selected)
5. With a crossover probability cross over the parents to form new offspring (children). If no crossover was performed, offspring is the exact copy of parents.
6. With a mutation probability mutate new offspring at each locus (position in chromosome)
7. Place new offspring in the new population
8. Use new generated population for a further run of the algorithm
9. If the end condition is satisfied, stop, and return the best solution in current population
10. Go to step 2
   Note that the genetic algorithm can be used to determine the location of the design variables in process 1102 as well as in the optimization process 116.

A swarming technique can be utilized in conjunction with the genetic algorithm in process 1102 and/or process 116 to home in on a region of interest where the magnitude of the adjoint field and gradients are of most significance. As an optimum is reached the swarm keeps getting smaller. This method could be effective for complicated adjoint fields. Swarming techniques generate a starting point and positions design variables around the starting point. The design variables are evaluated and the starting point is moved to an optimum position. A new swarm of design variables is generated around the updated starting point. The starting point can be moved a number of times before reducing the number of design variables. The reduction continues until an optimum is found.

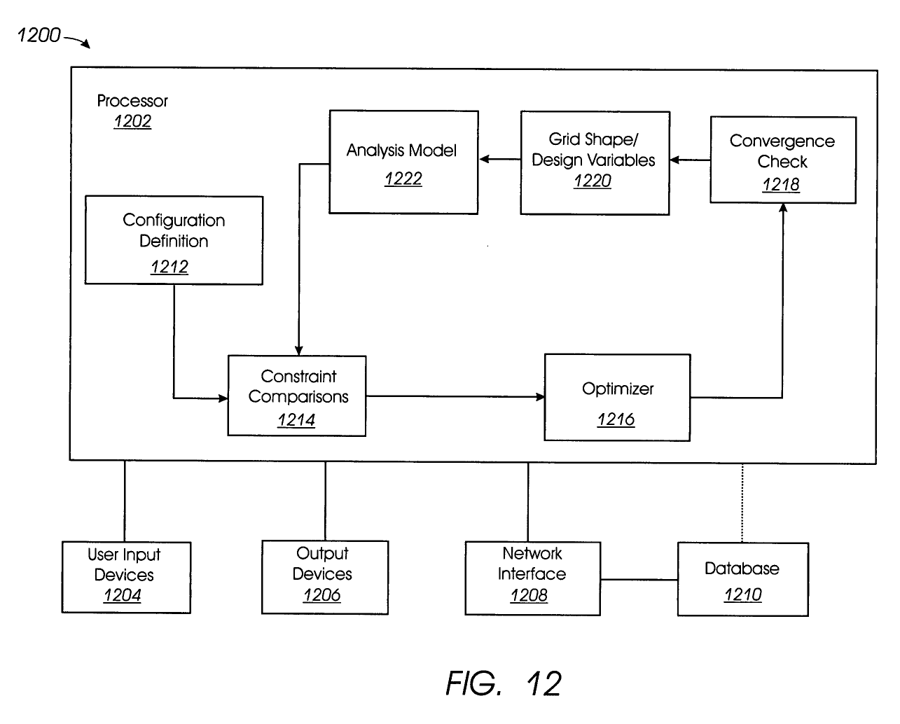

Referring to FIG. 12, a system 1200 is shown that can be used to implement processes 100, 1000, and 1100 with logic instructions, such as software programs that are executed by a processor 1202. The logic instructions can be distributed over an information network or suitable computer-readable media as a software application program that can be installed on a personal computer, a centralized server, or other suitable computer system. The logic instructions can also be implemented in hardware, firmware, and/or a combination of hardware, firmware and software. One or more user input devices 1204 can be provided, such as a keyboard, mouse, light pen, or a component such as a disk drive that can read data input files from a disk, to enable a designer to enter suitable constraints and design parameters. One or more output devices 1206 such as a display device, printer, plotter, or other suitable output device can be coupled to receive information from processor 1202. A user interface can also be included that provides instructions for using system 1200, possible design parameters that can be varied, as well as assistance in interpreting the results. The results can be formatted and output for use in other design systems, such as computer-aided design and drawing systems via network interface 1208, to easily share the results of the design effort. Processor 1202 can be configured to access a database 1210 either directly or via network interface 1208 for mass data storage and retrieval.

Processor 1202 can execute logic instructions that implement processes 102-120 (FIG. 1), 1002 (FIG. 10), and 1102 (FIG. 11). In the embodiment shown, configuration definition module 1212 can be configured to implement at least a portion of process 102. Constraint comparison module 1214 can be configured to implement at least a portion of optimizer process 116. Convergence check module 1216 can be configured to implement at least a portion of converged process 118. Optimization module 1218 can be configured to implement at least a portion of optimizer process 116. Grid shape/design variable module 1220 can be configured to implement at least portions of processes 108, 110, 112, and 120 for adjoint-based design variable adaptation. Analysis model 1222 can be configured to implement at least portions of processes 104, 106, 114, and 120. Other modules can be included in processor 1202 to provide the required functionality.

In addition to facilitating design of structural components, embodiments of techniques disclosed herein can be adapted to optimize the design of other aspects of a product, such as feedback control systems. For example, when designing control systems, the equations of motion for a design are used instead of field equations to determine a set of gain factors that provide optimal system stability during operation. The gain factors are used as the design variables, and can be varied until an optimal solution is reached. Also the field equations could involve multiple disciplines. As a consequence, the adjoint “field” could be multidisciplinary in nature. For example, when performing an aero-structural optimization, the optimum aerodynamic shape and aeroelastic shape are not the same.

Additionally, the design variables can be concentrated at the region of interest in some embodiments using a Neural Network algorithm to search for an optimum design variable distribution based on gradients and/or magnitudes of the adjoint field above or below a specified threshold. Neural Networks are an information processing technique based on the way biological nervous systems, such as the brain, process information. Neural networks are composed of a large number of highly interconnected processing elements or neurons, and use the human-like technique of learning by example to resolve problems. The neural network can be trained to recognize desirable configurations and adjustments can be made to the synaptic connections that exist between the neurons.

While the present disclosure describes various embodiments, these embodiments are to be understood as illustrative and do not limit the claim scope. Many variations, modifications, additions and improvements of the described embodiments are possible. For example, those having ordinary skill in the art will readily implement the processes necessary to provide the structures and methods disclosed herein. Variations and modifications of the embodiments disclosed herein may also be made while remaining within the scope of the following claims. The functionality and combinations of functionality of the individual modules can be any appropriate functionality. In the claims, unless otherwise indicated the article “a” is to refer to “one or more than one”.

What is claimed is:

1. A method for determining an optimum design comprising:
determining a initial solution for a design configuration based on an initial set of design variables;
determining an adjoint solution to the initial solution;
determining a region of interest on the design configuration based on at least one the gradients and the magnitudes of the adjoint solution; and
establishing design variables at the region of interest.

2. The method according to claim 1 wherein establishing design variables includes creating new design variables.

3. The method according to claim 1 wherein establishing design variables includes moving existing design variables to the region of interest.

4. The method according to claim 1 further comprising:
re-establishing the relationship between grids representing the design configuration and the design variables.

5. The method according to claim 1 further comprising:
determining whether an objective function has converged for the design variables.

6. The method according to claim 1 further comprising:
increasing the resolution of a Cartesian grid describing the design variables to increase the number of design variables outside the region of interest.

7. The method according to claim 1 further comprising:
decreasing the resolution of a Cartesian grid describing the design variables to decrease the number of design variables outside the region of interest.

8. The method according to claim 1 further comprising:
concentrating the design variables at the region of interest using a swarming technique based on at least one of the magnitudes and the gradients of the adjoint above or below a specified threshold.

9. The method according to claim I further comprising:
concentrating the design variables at the region of interest using a genetic algorithm to randomly search for an optimum solution based on at least one of the magnitudes and the gradients above a specified threshold.

10. A design system comprising:
logic instructions operable to:
determine a field solution for a design configuration based on an initial set of design variables;
determine an adjoint solution to the field solution;
determine a region of interest on the design configuration; and
establish design variables at the regions of interest.

11. The design system according to claim 10 wherein new design variables are created at the region of interest.

12. The design system according to claim 10 wherein existing design variables are moved to the region of interest.

13. The design system according to claim 10 wherein the logic instructions are further operable to:
re-establish the relationship between surface grids and the design variables.

14. The design system according to claim 10 wherein the logic instructions are further operable to:
determine whether the field solution has converged.

15. The design system according to claim 10 wherein the logic instructions are further operable to:
use an Octree adaptive grid of design variable locations to increase the number of design variables in the region of interest.

16. The design system according to claim 10 wherein the logic instructions are further operable to use an Octree adaptive grid of design variable locations to decrease the number of design variables outside the region of interest.

17. The design system according to claim 10 wherein the logic instructions are further operable to:
concentrate the design variables at the region of interest using a swarming technique based at least one of gradients and magnitudes above or below a specified threshold.

18. The design system according to claim 10 wherein the logic instructions are further operable to:
concentrate the design variables at the region of interest using a genetic algorithm to randomly search for an optimum location of design variables based on at least one of gradients and magnitudes of the adjoint field above or below a specified threshold.

19. The design system according to claim 10 wherein the logic instructions are further operable to:
concentrate the design variables at the region of interest using a Neural Network algorithm to search for an optimum design variable distribution based on at least one of gradients and magnitudes of the adjoint field above or below a specified threshold.

20. The design system according to claim 10, further comprising a processor.

21. The design system according to claim 10, wherein the logic instructions are distributed on a computer readable medium.

22. A system comprising:
means for determining a field solution for a design configuration based on an initial set of design variables;
means for determining an adjoint solution to the field solution;
means for determining a region of interest on the design configuration;
means for establishing new design variables at the regions of interest; and
means for moving existing design variables to the region of interest.
